(19) United States
(12) Patent Application Publication
(10) Pub. No.: US 2009/0184640 A1
(43) Pub. Date: Jul. 23, 2009

(54) RED PHOSPHOR COMPOSITION AND PLASMA DISPLAY PANEL INCLUDING THE SAME

(76) Inventor: Young-Gil Yoo, Suwon-si (KR)

Correspondence Address: CHRISTIE, PARKER & HALE, LLP, PO BOX 7068, PASADENA, CA, 91109-7068, US

(21) Appl. No.: 12/357,324

(22) Filed: Jan. 21, 2009

(30) Foreign Application Priority Data
Jan. 23, 2008 (KR) 10-2008-0006899

(51) Int. Cl. H01J 17/49; C09K 11/78

(52) U.S. Cl. 313/582; 252/301.4 R

(57) ABSTRACT

The present invention relates to a plasma display panel having a red phosphor including a first colored phosphor and a second non-colored phosphor. The plasma display panel includes a pair of substrates facing each other, at least one barrier rib between the pair of substrates for partitioning at least one discharge space, at least one electrode group on one of the substrates for generating discharge in the discharge space, and a phosphor layer for emitting light. The phosphor layer includes a red phosphor layer, a green phosphor layer, and a blue phosphor layer, and the red phosphor layer includes a first colored phosphor and a second non-colored phosphor.

### CROSS-REFERENCE TO RELATED APPLICATIONS

This application claims priority to and the benefit of Korean Patent Application No. 10-2008-0006899, filed on Jan. 23, 2008 in the Korean Intellectual Property Office, the entire content of which is incorporated herein by reference.

### BACKGROUND

1. Field of the Invention

The present invention relates to plasma display panels using red phosphors including a first colored phosphor and a second non-colored phosphor.

2. Discussion of Related Art

Plasma display panels are flat panel display apparatuses that display text or images through light emitted from plasma generated from gas discharge. Plasma display panels have excellent display capabilities, such as display capacity, brightness, contrast, after-image, viewing angle, etc.

A typical plasma display panel includes a first substrate and a second substrate facing each other, barrier ribs between the first substrate and the second substrate for partitioning discharge spaces, electrode groups disposed on the substrates for generating discharge in the discharge spaces, and phosphors disposed in the discharge spaces which emit light upon discharge. The substrates of the plasma display panel are mostly made of oxide-based materials, which are made through a burning process to impart higher external light reflectivity. However, these materials also give the flat panel display apparatuses low bright room contrast ratios.

In order to improve the bright room contrast ratio, a method of coloring the materials of the substrates is commonly used. For example, pigments have been attached to the surfaces of the phosphor powders to color them, or pigments have mixed into the phosphor paste to color the phosphor layer. Although this can considerably decrease the external light reflectivity of the substrates, it causes an off-balanced pigmentation due to the characteristics of the pigments attached to the red phosphor. The off-balanced pigmentation of the red phosphor causes the external color of the panel, that is, the reflective color of the panel, to show as red.

Also, coloring causes a drop in light efficiency, and applying (Y,Gd)BO3:Eu phosphor (which has the highest brightness among red phosphors) has been considered. However, although the (Y,Gd)BO3:Eu phosphor has high light efficiency, it does not have good color gamut, and therefore reduces the color gamut of the panel.

### SUMMARY OF THE INVENTION

According to one embodiment of the present invention, a plasma display panel includes a red phosphor having a first colored phosphor and a second non-colored phosphor. The plasma display panel shows improvements in reflective color change and color gamut.

In one embodiment, a plasma display panel includes a pair of substrates disposed facing each other, at least one barrier rib between the pair of substrates for partitioning at least one discharge space, at least one electrode group on the substrates for generating discharge in the discharge space, and a red-phosphor layer for emitting light from the discharge, wherein the red phosphor layer includes a first colored phosphor and a second non-colored phosphor.

In one exemplary embodiment, the brightness of the first phosphor is higher than that of the second phosphor. In another embodiment, the color purity of the second phosphor is higher than that of the first phosphor.

The first phosphor may include a red light emitting phosphor selected from (Y,Gd)BO₃:Eu, Y₂O₃:Eu, and combinations thereof. The second phosphor may include a red light emitting phosphor selected from Y(P,V)O₄:Eu, YAl₃(BO₃)₄:Eu, and combinations thereof.

The first phosphor is present in the red phosphor composition in an amount ranging from about 40 to about 60 percent by weight, and the second phosphor is present in an amount ranging from about 60 to about 40 percent by weight.

### BRIEF DESCRIPTION OF THE DRAWINGS

These and/or other embodiments and features of the invention will become more apparent by reference to the following detailed description when considered in conjunction with the accompanying drawings in which:

FIG. 1 is an exploded perspective view of a plasma display panel according to an embodiment of the present invention; and

FIG. 2 is an enlarged view of area A of FIG. 1.

### DETAILED DESCRIPTION OF PREFERRED EMBODIMENTS

Exemplary embodiments of the present invention will now be described with reference to the accompanying drawings. Elements that are not essential to the complete understanding of the invention are omitted for clarity. Also, like reference numerals refer to like elements throughout.

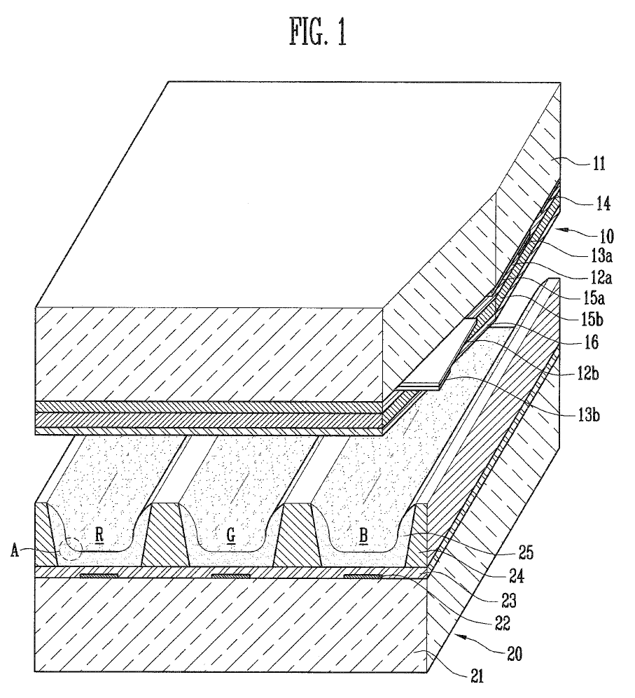

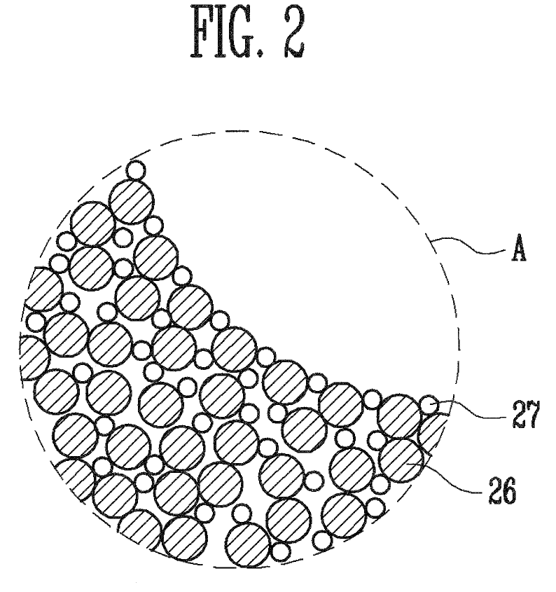

FIG. 1 is an exploded perspective view of a plasma display panel according to an embodiment of the present invention. FIG. 2 is an enlarged view of area A of FIG. 1. With reference to FIGS. 1 and 2, a three-electrode surface discharge AC type plasma display panel will be described as an illustrative example.

Referring to FIG. 1, a plasma display panel has a first substrate 11 and a second substrate 21 disposed facing each other. On the first substrate 11 and/or the second substrate 21, at least one barrier rib 24 is disposed between the substrates 11 and 21 and partitions at least one discharge space. At least one electrode group 12a, 12b, 13a, 13b and 22 generate discharge in the discharge space, and a phosphor layer 25 emits light from the discharge. At least some of the components may be formed on the first substrate 11 and, at least some of the components may be formed on the second substrate 21. The plasma display panel may include an upper plate 10 and a lower plate 20 disposed facing each other.

The phosphor layer 25 may have a red phosphor layer R, a green phosphor layer G, and a blue phosphor layer B.

The plasma display panel includes a red phosphor layer R made of a first colored phosphor colored with a colorant, and a second non-colored phosphor which is not colored with the colorant or a colorant having a similar color.

In detail, as shown in FIG. 1, sustain electrodes 12a and 12b, bus electrodes 13a and 13b, first dielectric layers 15a and 15b covering the electrodes 12a, 12b, 13a, and 13b, and a protective layer 16 covering the first dielectric layers 15a and 15b may be formed on a first surface of the first substrate 11. At least one address electrode 22, a second dielectric layer 23 covering the address electrodes 22, at least one barrier rib 24 partitioning discharge spaces on the second dielectric layer 23, and a phosphor layer 25 for emitting light from the discharge in the discharge spaces may be formed on a first surface of the second substrate 21. The discharge spaces correspond to discharge cells.

The first substrate 11 is formed of a transparent material through which visible rays can penetrate. The first substrate 11 may be formed of a glass substrate and specifically, a high strain point glass having less thermal distortion at high temperature.

The sustain electrodes 12a and 12b, which include two electrodes forming a pair that are disposed at an interval, serve to form an electric field in the discharge cells. The sustain electrodes 12a and 12b may be formed in a striped pattern and of materials having high visible-ray transmittance. The sustain electrodes 12a and 12b may be made of ITO, SnO₂, ZnO, CdSnO, etc. The sustain electrodes 12a and 12b may be formed by various existing film forming methods. For example, they may be formed with a thickness of about 1,000 Å by a thin film method using sputtering and photolithographic techniques.

The bus electrodes 13a and 13b apply nearly the same voltage to all the discharge cells by compensating for the relatively large resistance values of the sustain electrodes 12a and 12b. The bus electrodes 13a and 13b may have a fine width and may be made of materials having low electric resistance and that do not react with the dielectric layer 15a. The bus electrodes 13a and 13b made be made of gold (Au), silver (Ag), copper (Cu), chrome (Cr), etc. The bus electrodes 13a and 13b may be formed by various existing film forming methods. For example, they may be formed with a thickness of about 5 to about 10 μm by a thick film method using paste printing and/or photolithographic techniques.

A black layer 14 may be formed on the first substrate 11 and may be disposed in non-light emitting regions in a striped pattern between the sustain electrodes 12a and 12b for improving contrast ratio. The black layer 14 may be formed of materials having high densities. The black layer 14 may be formed by printing or photolithographic techniques, etc.

The first dielectric layers 15a and 15b limit discharge current, sustain glow discharge, and accumulate wall charges to perform memory functions. The first dielectric layers 15a and 15b may be formed of materials having high withstand voltages and high visible-ray transmittance. Nonlimiting examples of suitable materials for the first dielectric layers 15a and 15b include PbO, Bi₂O₃, ZnO, B₂O₃, etc. In one exemplary embodiment, the first dielectric layers 15a and 15b have a two-layer structure in order to have a uniform surface and to have a thickness over a threshold value. However, the first dielectric layers 15a and 15b may also have a one-layer structure or a multi-layer structure (e.g., more than three layers).

The protective layer 16 protects the first dielectric layers 15a and 15b from ion collisions and increases secondary electron emission parameters. The protective layer 16 may be formed of materials having high visible-ray transmittance, high surface insulation, and good resistance against ion sputtering. One nonlimiting example of a suitable material for the protective layer 16 is MgO. In one embodiment, the protective layer 16 is installed after a sealing material (to be explained further below) is formed.

Although not shown in FIG. 1, the first substrate 11 may be bonded to the second substrate 21 by injecting a gas such as neon, xenon, helium or a discharge gas mixed therewith between the first substrate 11 and the second substrate 21. A sealing material may be applied in a line shape around the edges of the substrates 11 and 21. The sealing material may be formed of materials having good adhesiveness and small residual stress. As the materials of the sealing material, various existing frit bonding materials such as low melting point glass frits, etc. may be used.

The second substrate 21 may be formed of the same materials as the first substrate 11, such as a transparent glass substrate. Alternatively, the second substrate 21 may be formed of another opaque glass substrate.

The address electrodes 22 serve to subscribe image data on the respective discharge cells. The address electrodes 22 are formed on the second substrate 21 in a striped pattern. The address electrodes 22 extend in a direction intersecting the sustain electrodes 12a and 12b. The address electrodes 22 may be formed of materials having high electric conductivity, for example, gold (Au), silver (Ag), etc. The address electrodes 22 may be formed using various existing thick film methods. For example, the address electrodes 22 may be formed with a thickness of about 5 to 10 μm using a paste printing technique.

The second dielectric layer 23 is formed on the second substrate 21 to protect the address electrodes 22 and to impart high dielectric strength. The second dielectric layer 23 may be formed of materials having high light reflectivity. As the materials of the second dielectric layer 23, PbO, SiO₂, B₂O₃, etc., may be used.

The barrier ribs 24 enhance color purity by preventing the diffusion of the discharge region in a longitudinal direction and the color mixture of visible rays. The barrier ribs 24 also serve to impart strength for supporting the first substrate 11. The barrier ribs 24 may have narrow widths and moderately higher heights for forming the discharge space. Also, the barrier ribs 24 may be made of materials having closely-packed textures for suppressing inhalation of organic materials due to the phosphor paste. The barrier ribs 24 may be formed by printing techniques, sand blasting techniques, etc., and may be formed of materials such as PbO, SiO₂, B₂O₃, etc. Also, the uppermost layers of the barrier ribs 24 may be formed with separate black layers to improve contrast ratio.

The phosphor layer 25 transforms ultraviolet rays generated by the discharge into visible rays and emits the transformed visible rays. The phosphor layer 25 may be made of materials having good light transformation efficiency and good color purity. The phosphor layer 25 includes a red phosphor layer R, a green phosphor layer G, and a blue phosphor layer B.

Nonlimiting examples of suitable materials for the green phosphor layer G include Zn₂SiO₄:Mn, Y₂SiO₅:Mn, BaAl₁₂O₁₉:Mn, (LaCe)PO4:Tb, CeMgAl₁₁O₁₉:Tb, and combinations thereof.

Nonlimiting examples of suitable materials for the blue phosphor layer B include BaMgAl₁₀O₁₇:Eu, BaMgAl₁₄O₂₃:Eu, BaMg₂Al₁₆O₂₇:Eu, (BaSrMg)₁₀(PO₄)₆C₁₂:Eu, and combinations thereof.

The red phosphor layer R includes a first colored phosphor 26 and a second non-colored phosphor 27, as shown in FIG. 2. In FIG. 2, the first phosphor 26 is larger than the second phosphor 27 for the sake of easy explanation. The brightness of the first phosphor 26 is higher than that of the second phosphor 27, and the color purity of the second phosphor 27 is higher than that of the first phosphor 26. The red phosphor layer R including a first colored phosphor 26 mixed with a second non-colored phosphor 27 imparts the desired brightness and color purity.

The first phosphor 26 may be a borate-based red light emitting phosphor that is excited by vacuum ultraviolet rays of about 147 nm or about 172 nm to emit light in the visible region. More specifically, an exemplary red light emitting phosphor has (Y,Gd)BO₃ (having good brightness properties) as the host and Eu³⁺ as the activator.

The chemical composition of a (Y,Gd)BO₃:Eu red phosphor is represented by (Y_{1-x-y}Gdₓ)BO₃:yEu, wherein the red phosphor intended to be applied to a PDP has x and y value ranges of 0.2≦x≦0.5 and 0.01≦y≦0.2. As the first phosphor 26, a Y₂O₃:Eu phosphor, etc. (among phosphors commonly used as an existing red phosphor for PDP), having high light emitting efficiency may also be used.

As the second phosphor 27, a deep red-based red light emitting phosphor having good color gamut is used despite its inferior brightness properties relative to the first phosphor 26. For example, Y(P,V)O₄:Eu and/or YAl₃(BO₃)₄:Eu phosphors may be used as the red light emitting phosphor of the second phosphor 27.

The manufacturing process of the red phosphor used in the red phosphor layer R will now be described. First, the first colored phosphor 26 is prepared by mixing (Y,Gd)BO₃:Eu phosphor powder with pigments and burning them.

Next, the second non-colored phosphor 27 is prepared using Y(P,V)O₄:Eu, and the second phosphor 27 is then mixed with the first colored phosphor 26. The amount of the first phosphor 26 ranges from about 40 to about 60 percent by weight, and the amount of the second phosphor 27 ranges from about 60 to about 40 percent by weight. The amount of the first and second phosphors in the red phosphor is selected such that the brightness of the red phosphor layer R is approximately 70% of the brightness of the green phosphor layer G and blue phosphor layer B. In one embodiment, for example, the red phosphor include 40 percent by weight of the first phosphor 26 and 60 percent by weight of the second phosphor 27.

According to one embodiment of the present invention, when the red phosphor includes about 40 percent by weight of the first phosphor 26 and about 60 percent by weight of the second phosphor 27, good bright room contrast ratio may be obtained.

Next, a plasma display panel is manufactured using a red phosphor paste prepared by mixing the first phosphor 26 and the second phosphor 27. For example, the red phosphor paste is printed and/or dispensed within the discharge spaces formed by the barrier ribs 24. The paste is then dried and burnt, thereby forming the red phosphor layer R.

In order to evaluate the performance of the red phosphors of the present invention, the properties of the inventive red phosphors (Example 1) are compared with the properties of red phosphors including all non-colored phosphors (Comparative Example 1) and red phosphors including all colored phosphors (Comparative Example 2). prepared in another condition is also evaluated. The experimental result is as shown in the following Table 1.

TABLE 1

| | External light | External light | Color | | |
|---|---|---|---|---|---|
| Phosphor | reflection brightness | reflectivity | reproducibility | a* | b* |
| Comp. Ex. 1: | 10.12 | 100% | 92% | −0.95 | −3.34 |
| Non-colored R1 | | | | | |
| (40 wt %) + non- | | | | | |
| colored R2 (60 wt %) | | | | | |
| Comp. Ex. 2: | 8.78 | 86.7% | 80% | 2.06 | −0.84 |
| colored R1 (40 wt %) + | | | | | |
| colored R2 (60 wt %) | | | | | |
| Ex. 1: | 9.02 | 89% | 85% | 1.35 | −0.62 |
| colored R1 (40 wt %) + | | | | | |
| non-colored R2 | | | | | |
| (60 wt %) | | | | | |

As shown in Table 1, Comparative Example 1 includes first and second phosphors, both of which are not colored, Comparative Example 2 includes first and second phosphors, both of which are colored, and Example 1 includes a first colored phosphor and a second non-colored phosphor.

In Comparative Example 1, the red phosphor included 40 percent by weight of a non-colored (Y,Gd)BO₃:Eu first phosphor R1 and 60 percent by weigh of a non-colored Y(P,V)O₄:Eu second phosphor. In Comparative Example 2, the red phosphor included 40 percent by weight of a colored (Y,Gd)BO₃:Eu first phosphor R1 and 60 percent by weight of a colored Y(P,V)O₄:Eu second phosphor. In Example 1, the red phosphor included 40 percent by weight of a colored (Y,Gd)BO₃:Eu first phosphor R1 and 60 percent by weight of a non-colored Y(P,V)O₄:Eu second phosphor R2.

As appreciated from Table 1, Comparative Example 1 exhibits an external light reflection brightness of 10.12, and external light reflectivity of 100%, and a color gamut of 92%. Comparative Example 2 exhibits an external light reflection brightness of 8.78, an external light reflectivity of 86.7%, and a color gamut of 80%. However, Example 1 exhibits an external light reflection brightness 9.02, an external light reflectivity of 89%, and a color gamut of 85%. Accordingly, the red phosphors according to the present invention can lower external light reflection brightness of the red phosphor layer by 10% or more and increase color gamut by 5% or more, while improving the bright room contrast ratio by 10% or more. The red phosphors of the present invention can also move the reflective color from a red-based region to a gray region.

According to embodiments of the present invention, a red phosphor includes a first colored phosphor and a second non-colored phosphor, thereby lowering external light reflection brightness of the plasma display panel, improving the bright room contrast ratio of the panel and increasing color gamut. Furthermore, the reflective color is moved from the red-based region to the gray region, thereby improving the bright room contrast ratio. Also, when the reflective color of the plasma display panel is moved to a green or blue-based region by the development of a green or blue phosphor having a higher brightness than the red phosphor, the change in reflective color and color gamut may be easily improved.

Although exemplary embodiments of the present invention have been illustrated and described, those of ordinary skill in the art appreciate that various modifications and changes may be made to the described embodiments without departing from the principle, spirit and scope of the invention as defined in the following claims and their equivalents.

What is claimed is:

1. A red phosphor composition comprising a first colored phosphor and a second non-colored phosphor.

2. The red phosphor composition as claimed in claim 1, wherein the first colored phosphor has a higher brightness than the second non-colored phosphor.

3. The red phosphor composition as claimed in claim 2, wherein the second non-colored phosphor has a higher color purity than the first colored phosphor.

4. The red phosphor composition as claimed in claim 1, wherein the first colored phosphor comprises a red light emitting phosphor selected from the group consisting of (Y,Gd)BO₃:Eu, Y₂O₃:Eu, and combinations thereof.

5. The red phosphor composition as claimed in claim 4, wherein the second non-colored phosphor comprises a red light emitting phosphor selected from the group consisting of Y(P,V)O₄:Eu, YAl₃(BO₃)₄:Eu, and combinations thereof.

6. The red phosphor composition as claimed in claim 5, wherein the first colored phosphor is present in the red phosphor in an amount ranging from about 40 to 60 percent by weight, and wherein the second non-colored phosphor is present in the red phosphor in an amount ranging from about 60 to about 40 percent by weight.

7. A plasma display panel comprising:
first and second substrates;
at least one barrier rib between the first and second substrates, the at least one barrier rib defining at least one discharge space;
at least one electrode group on one of the first and second substrates for generating discharge in the at least one discharge space; and
a phosphor layer for emitting light, the phosphor layer comprising a red phosphor layer, wherein the red phosphor layer comprises a first colored phosphor and a second non-colored phosphor.

8. The plasma display panel as claimed in claim 7, wherein the first colored phosphor has a higher brightness than the second non-colored phosphor.

9. The plasma display panel as claimed in claim 8, wherein the second non-colored phosphor has a higher color purity than the first colored phosphor.

10. The plasma display panel as claimed in claim 7, wherein the first colored phosphor comprises a red light emitting phosphor selected from the group consisting of (Y,Gd)BO₃:Eu, Y₂O₃:Eu, and combinations thereof.

11. The plasma display panel as claimed in claim 10, wherein the second non-colored phosphor comprises a red light emitting phosphor selected from the group consisting of Y(P,V)O₄:Eu, YAl₃(BO₃)₄:Eu, and combinations thereof.

12. The plasma display panel as claimed in claim 11, wherein the first colored phosphor is present in the red phosphor in an amount ranging from about 40 to 60 percent by weight, and wherein the second non-colored phosphor is present in the red phosphor in an amount ranging from about 60 to about 40 percent by weight.
